(19) United States
(12) Patent Application Publication
(10) Pub. No.: US 2025/0310991 A1
(43) Pub. Date: Oct. 2, 2025

(54) WIRELESS COMMUNICATION DEVICE, WIRELESS COMMUNICATION METHOD, AND WIRELESS COMMUNICATION SYSTEM

(71) Applicant: Nippon Telegraph and Telephone Corporation, Tokyo (JP)

(72) Inventors: Shoko SHINOHARA, Musashino-shi, Tokyo (JP); Yusuke Asai, Musashino-shi, Tokyo (JP); Yoshitaka SHIMIZU, Musashino-shi, Tokyo (JP); Junichi Iwatani, Musashino-shi, Tokyo (JP); Tomoyuki Yamada, Musashino-shi, Tokyo (JP); Yasushi TAKATORI, Musashino-shi, Tokyo (JP)

(21) Appl. No.: 18/854,851

(22) PCT Filed: Apr. 14, 2022
(86) PCT No.: PCT/JP2022/017871

§ 371 Date: Oct. 7, 2024

(51) Int. Cl. H04W 74/0808; H04W 74/08; H04W 84/12

(52) U.S. Cl. CPC H04W 74/0808; H04W 74/0866; H04W 84/12

(57) ABSTRACT

The present disclosure relates to a wireless communication device, a wireless communication method, and a wireless communication system which perform communication between a plurality of wireless communication modules. A wireless communication device of the present disclosure includes a plurality of wireless communication modules including a signal reception unit, an access control unit, and a signal transmission unit, in which: the signal reception unit receives a wireless communication signal; the access control unit performs determination of carrier sensing not only for a channel of occupied frequencies, but also for an adjacent channel; and the signal transmission unit performs wireless transmission based on the determination.

### TECHNICAL FIELD

The present disclosure relates to a wireless communication device, a wireless communication method, and a wireless communication system, and relates to a wireless communication device, a wireless communication method, and a wireless communication system which perform communication between a plurality of wireless communication modules.

### BACKGROUND ART

In the field of wireless communication, there has been conventionally known a method of relaying a wireless signal by using a repeater or the like to expand an area. For example, in a case where two wireless communication modules provided in the repeater communicate with terminals in different areas, a relay between two areas can be performed by transferring a packet received in the repeater.

In order to use the two wireless communication modules in the same housing, it is necessary to avoid wireless interference. Frequency division is known as avoiding means. As the frequency division, for example, there is known a method in which each wireless communication module uses sufficiently separate frequency channels to completely avoid the above collision of wireless signals.

In a case where a plurality of wireless communication modules performs communication in the same area, carrier sensing is generally performed to avoid a collision of wireless signals caused by matching of wireless transmission timings. Carrier sensing is a function of, before a signal is transmitted from its own terminal, confirming whether or not a signal has been transmitted from another terminal during a certain time+a random time. The signal confirmed at this time is limited to a range of a frequency channel used by its own terminal.

### CITATION LIST

### Non Patent Literature

Non Patent Literature 1: IEEE Standard for Information Technology-Telecommunications and Information Exchange between Systems—Local and Metropolitan Area Networks-Specific Requirements—Part 11: Wireless LAN Medium Access Control (MAC) and Physical Layer (PHY) Specifications

### SUMMARY OF INVENTION

### Technical Problem

However, in the conventional frequency division, in a case where the number of available frequency channels is small, channels having sufficiently separate frequencies cannot be prepared. In this case, for example, adjacent channels are used. In that case, when each wireless communication module performs carrier sensing only on a channel used by its own terminal and uses the channel, wireless signals collide due to power leaking from an adjacent channel.

In order to solve the above problem, a first object of the present disclosure is to provide a wireless communication device capable of avoiding signal interference between a plurality of wireless communication modules using adjacent channels by expanding a range of frequency channels to be subjected to carrier sensing to the adjacent channel.

### Solution to Problem

A first aspect of the present disclosure is preferably a wireless communication device including a plurality of wireless communication modules including a signal reception unit, an access control unit, and a signal transmission unit, in which: the signal reception unit receives a wireless communication signal; the access control unit performs determination of carrier sensing not only for a channel of occupied frequencies, but also for an adjacent channel; and the signal transmission unit performs wireless transmission based on the determination.

A second aspect of the present disclosure is preferably a wireless communication method, in which a plurality of wireless communication modules performs reception processing of receiving a wireless communication signal, determination processing of performing determination of carrier sensing not only for a channel of occupied frequencies, but also for an adjacent channel, and transmission processing of performing wireless communication based on a result of the determination processing.

A third aspect of the present disclosure is preferably a wireless communication system including: a plurality of signal reception units that receives a wireless communication signal; a plurality of access control units that performs determination of carrier sensing not only for a channel of occupied frequencies, but also for an adjacent channel; and a plurality of signal transmission units that performs or stops wireless communication based on the determination.

### Advantageous Effects of Invention

According to the first to third aspects of the present disclosure, it is possible to provide a wireless communication device, a wireless communication method, and a wireless communication system capable of avoiding signal interference between a plurality of wireless communication modules using adjacent channels by expanding a range of frequencies to be subjected to carrier sensing to the adjacent channel.

### BRIEF DESCRIPTION OF DRAWINGS

FIG. 1 is a graph showing a transmission spectrum mask of a wireless signal spectrum.

FIG. 2 is a graph showing an example of reception intensity observed by a repeater.

FIG. 3 shows a configuration of a wireless communication system according to a first embodiment of the present disclosure.

FIG. 4 shows a configuration of frequency channels according to the first embodiment of the present disclosure.

FIG. 5 shows a configuration of a wireless communication repeater of the present disclosure.

FIG. 6 is a graph showing a range of frequency channels detected by carrier sensing according to the first embodiment of the present disclosure.

FIG. 7 shows a frame of a wireless signal according to a second embodiment.

### DESCRIPTION OF EMBODIMENTS

### First Embodiment

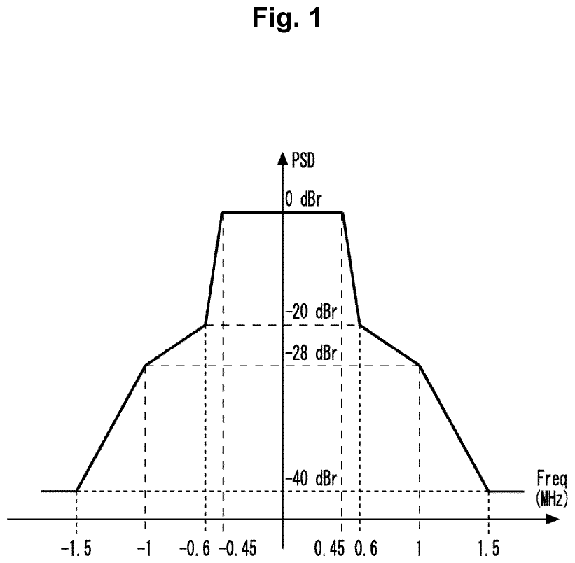

Before description of a first embodiment, problems arising in the conventional method when a plurality of wireless communication modules perform communication will be described. FIG. 1 is a graph showing a transmission spectrum mask of a wireless signal spectrum. Here, FIG. 1 shows a transmission spectrum mask in the 1 MHz band defined by IEEE 802.11ah.

From the graph of FIG. 1, it can be seen that power spectral density may be −20 dBr (decibels relative to reference level) even at a frequency 0.6 MHz away from the center frequency. For example, in a case where signal power density of a main lobe is 3 dBm/100 kHz, the signal power density is −17 dBm/100 kHz at a frequency position 600 kHz away from the center.

Here, it can be said that attenuation in a wireless space is sufficient if the attenuation is equal to or less than 20 dB, for example. That is, in a transmission spectrum of a channel having a width of 1 MHZ, the attenuation is considered to be insufficient even at a frequency 0.5 MHz or more away from the center frequency outside a channel range. Therefore, the attenuation is insufficient if this signal is received at an extremely close location, and only leakage power causes large interference. That is, it can be seen that, in a case where the frequency division is performed to avoid wireless interference, the frequency division may not sufficiently play a role in adjacent frequency channels.

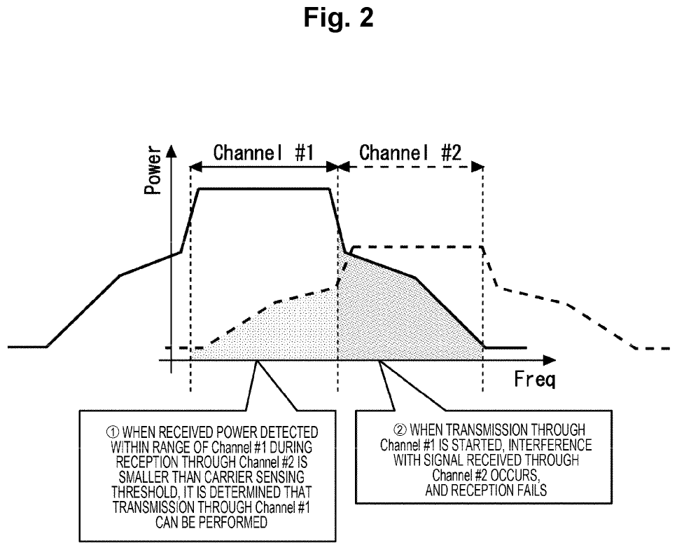

FIG. 2 is a graph showing an example of reception intensity observed by a repeater. Here, FIG. 2 shows frequency channels used by two wireless communication modules included in the repeater and power intensities thereof. A channel #1 is a frequency channel used by a wireless communication module #1, and a channel #2 is a frequency channel used by a wireless communication module #2. The channel #1 and the channel #2 are adjacent frequency channels.

For example, there will be described a case where the wireless communication module #1 starts transmitting a signal by using the channel #1 while the wireless communication module #2 is receiving a signal through the channel #2. In the conventional method, the wireless communication module #1 detects a signal only within a range of the channel #1 by carrier sensing. Therefore, the wireless communication module #1 detects only power leaking from the channel #2 to the channel #1 and determines a carrier sensing result. At this time, in a case where the power leaking from the channel #2 is lower than a carrier sensing threshold, it is determined that the wireless communication module #2 is in an idle state. Therefore, the wireless communication module #1 starts transmitting a signal by using the channel #1.

However, the wireless communication module #2 is actually receiving a signal through the channel #2. Here, when the wireless communication module #1 starts transmitting a signal, power leaks from the channel #1 to the channel #2. Due to interference from the leakage power, a demodulation error occurs in the signal received by the wireless communication module #2 through the channel #2, and thus reception of the signal fails.

As described above, in a case where adjacent frequency channels are used, wireless interference may not be avoided. Further, as another example where the two wireless communication modules use different frequency channels, there is a case where optimal frequency channels are different because an interference situation is different in each area in which the repeater communicates. However, in a case where the optimal frequency channels are adjacent to each other, a problem similar to that in the case of FIG. 2 may occur.

In the present disclosure, in a case where wireless devices installed in the repeater or in extremely close locations use adjacent channels, a range of frequencies to be subjected to carrier sensing is expanded to the adjacent channel. Therefore, signal interference between a plurality of wireless communication modules using adjacent channels is avoided.

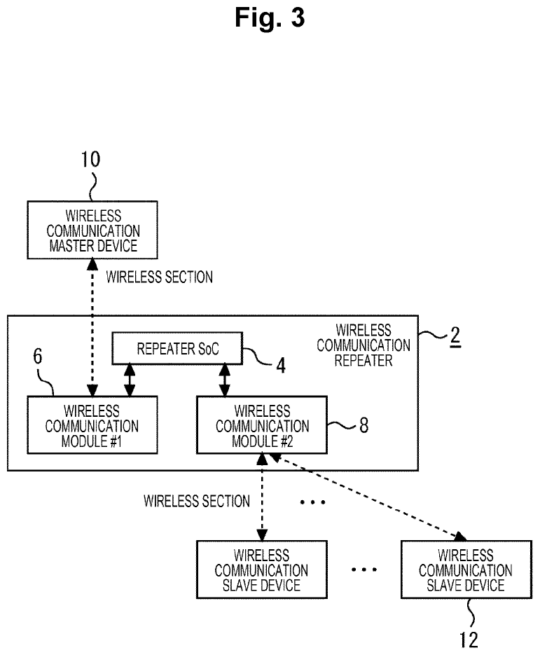

Hereinafter, the first embodiment will be described. FIG. 3 shows a configuration of a wireless communication system according to the first embodiment of the present disclosure. The wireless communication system includes a wireless communication repeater 2. The wireless communication repeater 2 includes a repeater 4 and is, for example, an SoC (system on chip). The repeater 4 relays wireless communication between the wireless communication modules 6 and 8 serving as wireless communication modules. The wireless communication modules 6 and 8 are, for example, NICs (network interface controllers). The wireless communication module 6 performs wireless communication with a wireless communication master device 10. The wireless communication module 8 performs wireless communication with a plurality of wireless communication slave devices 12.

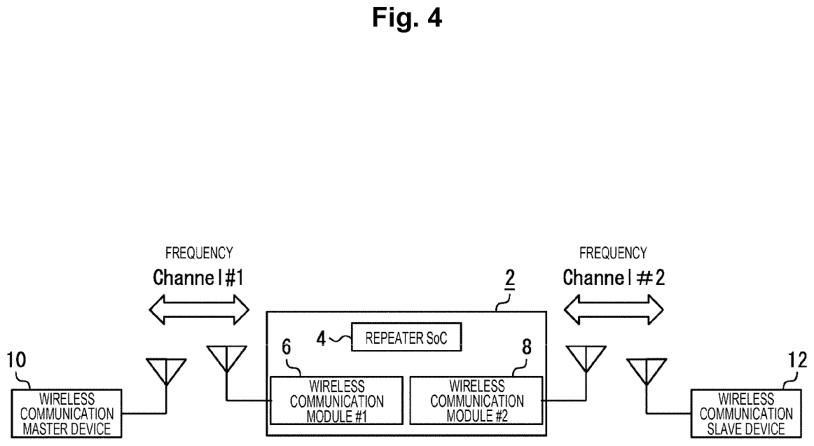

FIG. 4 shows a configuration of frequency channels according to the first embodiment of the present disclosure. In the wireless communication system according to the first embodiment, the frequency channel #1 is used for wireless communication between the wireless communication module 6 and the wireless communication master device 10, and the frequency channel #2 is used for wireless communication between the wireless communication module 8 and the wireless communication slave device 12.

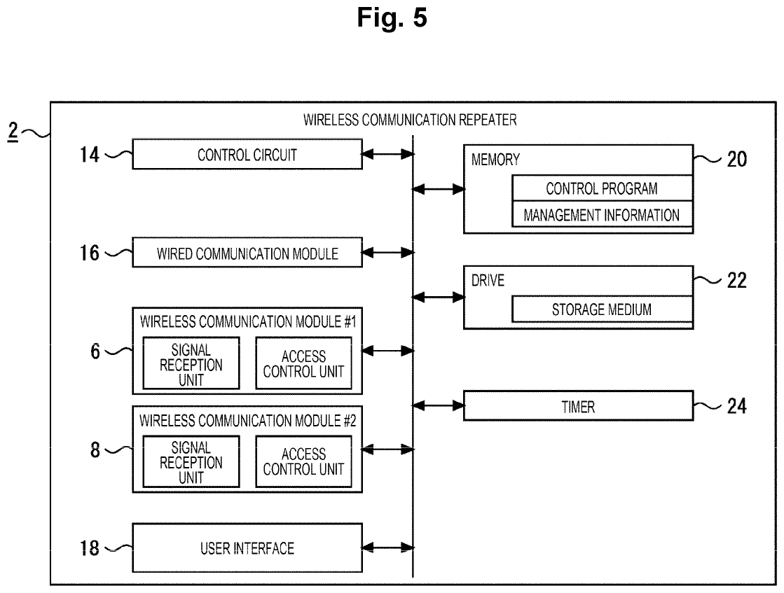

FIG. 5 shows a configuration of the wireless communication repeater of the present disclosure. The wireless communication repeater 2 includes the wireless communication modules 6 and 8 also as shown in FIG. 3. The wireless communication modules 6 and 8 include a signal reception unit that receives wireless communication, an access control unit that performs determination of carrier sensing for a signal received by the signal reception unit, and a signal transmission unit (not shown) that transmits wireless communication. Occupied frequencies of the wireless communication modules 6 and 8 are adjacent to each other. Note that, although three or more wireless communication modules may be included, the present disclosure shows a configuration including two wireless communication modules.

The wireless communication repeater 2 includes a control circuit 14. The control circuit 14 controls an observation period and a start timing by using management information in accordance with a management program included therein.

The wireless communication repeater 2 includes a wired communication module 16. The wired communication module 16 has a function of performing wired communication and is used, for example, when performing wired communication with another repeater. The wireless communication repeater 2 also includes a user interface 18. The user interface 18 is a module used when setting of the wireless communication repeater 2 is changed from the outside and is, for example, a controller operated by a user.

The wireless communication repeater 2 includes a memory 20. The memory 20 stores a control program and the management information. The wireless communication repeater 2 also includes a drive 22. The drive 22 includes a storage medium and stores setting information and the like of the repeater. The wireless communication repeater 2 further includes a timer 24. The timer 24 measures, for example, time related to wireless communication of the repeater.

Note that a control unit included in the device of the present disclosure can also be implemented by a computer and a program, and the program can be recorded in a recording medium or be provided via a network.

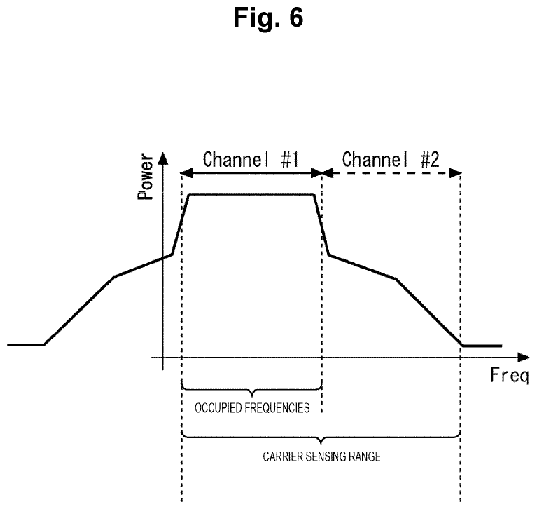

FIG. 6 is a graph showing a range of frequency channels detected by carrier sensing according to the first embodiment of the present disclosure. The channel #1 is occupied frequencies of the wireless communication module 6, and the channel #2 is occupied frequencies of the wireless communication module 8. As described above, the occupied frequencies are adjacent to each other.

In carrier sensing according to the present disclosure, in a case where terminals installed in the same housing or in extremely close locations use adjacent channels, a range of frequency channels including not only occupied frequencies serving as a channel to which a signal is transmitted, but also its adjacent channel is set as a carrier sensing range. In the wireless communication repeater 2, the wireless communication module 6 sets a range of frequency channels including not only the channel #1 but also the adjacent channel #2 as the carrier sensing range.

By expanding the range of frequencies in which carrier sensing is performed, it is possible to perform carrier sensing in consideration of an adjacent channel affected by leakage power. As a result, it is possible to provide a wireless communication device capable of avoiding signal interference between a plurality of wireless communication modules using adjacent channels and further improving throughput.

In the conventional example, a filter at the time of reception is prepared for each channel. For example, when the filter is changed to a filter covering the entire adjacent channel, the above configuration can be implemented without complicating a configuration at the time of reception.

For the adjacent channel, the carrier sensing threshold used for threshold determination in the signal reception unit in the wireless communication module may be changed. The two wireless communication modules 6 and 8 according to the first embodiment are devices of the same model included in the same wireless communication repeater 2, and thus signals received by the two wireless communication modules 6 and 8 have substantially the same power. Here, a case where carrier sensing is performed in the wireless communication module 6 will be described. In a case where wireless communication is performed in the wireless communication module 8, it is assumed that power leaking from the channel #2 to the channel #1 is lower than power used in wireless communication by the channel #1. That is, in a period in which communication power is low, for example, at the start of wireless communication and immediately before the end thereof in the wireless communication module 8, a possibility of occurrence of wireless interference is low even if the wireless communication module 6 performs wireless communication. As described above, it is considered that it is unnecessary to restrain wireless communication of the wireless communication module 6 unless power consumption of the wireless communication module 8 is sufficiently high.

Therefore, for example, the carrier sensing threshold of the adjacent channel is set higher than that of the occupied frequencies. Specifically, in a case where carrier sensing is performed in the wireless communication module 6, the carrier sensing threshold of the channel #2 is set higher than the carrier sensing threshold of the channel #1. By reducing sensitivity of carrier sensing in the adjacent channel in this way, wireless communication can be efficiently performed without restraining wireless transmission more than necessary.

There will be described a case where an unrelated wireless communication module outside the wireless communication system performs wireless communication using an adjacent channel in a close location. A radio wave from the wireless communication module may cause wireless interference in a case where the power intensity is high. However, an influence thereof is assumed to be small, as compared with the wireless communication module inside the same repeater. Therefore, wireless communication can be efficiently performed by setting a high carrier sensing threshold to the adjacent channel to reduce the sensitivity of carrier sensing.

Further, determination of the carrier sensing result may be changed with reference to a reception state or the like of each wireless communication module. For example, it is possible to detect a reception failure rate of the wireless communication module 8 by issuing a transmission failure rate of the wireless communication slave device 12. Here, in a case where the reception failure rate of the wireless communication module 8 is high, leakage power caused by the wireless communication module 6 is larger than expected, and wireless interference may occur. Therefore, the determination is changed to stop wireless communication of the wireless communication module 6. As described above, when the determination of the carrier sensing result of the wireless communication module 6 is changed based on information such as the reception failure rate of the adjacent wireless communication module, thereby performing wireless communication more efficiently.

### Second Embodiment

A second embodiment is similar to the first embodiment in a device configuration and the like, but is different in that carrier sensing is performed only on a specific wireless signal. For example, a BSS identifier such as BSS color of a signal received in the adjacent channel is also grasped. Therefore, only signals related to the wireless communication modules, the repeater including the wireless communication modules, and the like serve as a target of determination in carrier sensing. In this way, only wireless signals whose interference is to be avoided are determined, and thus it is possible to avoid excessive regulation of wireless communication.

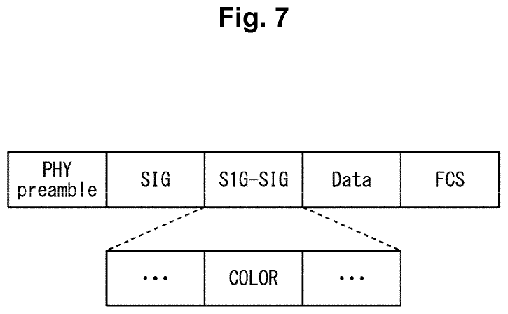

FIG. 7 shows a frame of a wireless signal according to the second embodiment. As a method of identifying a wireless signal whose interference is to be avoided, there is a method of using a COLOR field for identifying a basic service set (BSS) serving as a cell of a wireless LAN. A value of the COLOR field is used as a simple BSS identifier.

In a case where the COLOR field of a received signal has a value whose interference is to be avoided, the carrier sensing threshold for the value is set low. For example, the same COLOR field value is set to identifiers used by the wireless communication modules in the same housing, and the carrier sensing threshold is changed when the value is detected. Alternatively, the COLOR field value used by a near wireless communication module is grasped, and the carrier sensing threshold is changed when the value is detected. As a result, it is possible to suppress simultaneous occurrence of wireless communication that tends to cause interference, thereby easily avoiding interference.

In a case where the COLOR field of the received signal does not have a value whose interference is to be avoided, the carrier sensing threshold for the value is set high. The COLOR field has several bits of types, and thus a different value is set to a terminal outside the wireless communication system with high probability. Therefore, for example, the carrier sensing threshold is changed except for the COLOR field value that may interfere. As a result, it is possible to increase the number of transmission opportunities from the own terminal, and thus improvement in throughput can be expected.

### REFERENCE SIGNS LIST

6 Wireless communication module

8 Wireless communication module

1. A wireless communication device comprising
a plurality of wireless communication modules including a signal receptor, an access control circuitry, and a signal transmitter, wherein:
the signal receptor receives a wireless communication signal;
the access control circuitry performs determination of carrier sensing not only for a channel of occupied frequencies, but also for an adjacent channel; and
the signal transmitter performs wireless transmission based on the determination.

2. The wireless communication device according to claim 1, wherein
the access control circuitry changes a carrier sensing threshold between the channel of the occupied frequencies and the adjacent channel.

3. The wireless communication device according to claim 1, wherein the access control circuitry
detects a reception state of another wireless communication module, and
changes the determination based on the reception state.

4. The wireless communication device according to claim 1, wherein:
the wireless communication signal has a COLOR field; and
the access control circuitry changes a carrier sensing threshold based on a value of the COLOR field.

5. The wireless communication device according to claim 1, wherein the wireless communication module includes a reception filter covering the channel of the occupied frequencies and the adjacent channel.

6. A wireless communication method, wherein
a plurality of wireless communication modules performs receiving a wireless communication signal,
determination of carrier sensing not only for a channel of occupied frequencies, but also for an adjacent channel, and
wireless communication based on a result of the determination processing.

7. A wireless communication system comprising:
a plurality of signal receptors that receives a wireless communication signal;
a plurality of access control circuitry that performs determination of carrier sensing not only for a channel of occupied frequencies, but also for an adjacent channel; and
a plurality of signal transmitters that performs or stops wireless communication based on the determination.
